(19) United States
(12) Patent Application Publication
(10) Pub. No.: US 2013/0212633 A1
(43) Pub. Date: Aug. 15, 2013

(54) Systems And Methods For Communicating With Patients

(71) Applicants: William Emerson, Coventry, CT (US); Patrick Caruso, Southington, CT (US)

(72) Inventors: William Emerson, Coventry, CT (US); Patrick Caruso, Southington, CT (US)

(21) Appl. No.: 13/584,893

(22) Filed: Aug. 14, 2012

Related U.S. Application Data
(60) Provisional application No. 61/525,037, filed on Aug. 18, 2011.

(51) Int. Cl. H04N 21/61

(52) U.S. Cl. CPC H04N 21/6125
USPC 725/106

(57) ABSTRACT

Methods and systems for communicating with a patient through a television in the patient's hospital room are disclosed. In some embodiments, the methods and systems include the following: a television signal gateway module for receiving televisions signals and encoding the signals as Ethernet-based Internet protocol television signals; an application and media server including a first information processing sub-system configured to store and process the signals and data according to instructions and configured to generate, send, and receive Ethernet-based Internet protocol application and media signals; and an interactive set-top-box including a second information processing sub-system that is configured to store and process instructions and configured to process the Ethernet-based Internet protocol television signals and the Ethernet-based Internet protocol application and media signals to produce television display signals, the set-top-box being configured to communicate the television display signals for display on the television in the patient's hospital room.

### CROSS REFERENCE TO RELATED APPLICATION(S)

This application claims the benefit of U.S. Provisional Application Nos. 61/525,037, filed Aug. 18, 2011, which is incorporated by reference as if disclosed herein in its entirety.

### BACKGROUND

Research has shown that patient anxiety can be lessened by better communicating information about the patient's care before, during, and after their hospital stay. Currently, few, if any, technology exists that provides a comprehensive solution to enhancing communication of patient information to patients.

Known technology is outdated and based on systems for providing on-demand entertainment to lodging establishments. Such systems fail to consider the many nuances related to communicating patient information to patients before, during, and after their hospital stay.

### SUMMARY

Some embodiments of the disclosed subject matter include systems and methods for communicating with a patient through a television in the patient's hospital room. In some embodiments, a television signal comes in from either a satellite feed or a cable feed and is pushed through a box known as television signal gateway module, which encodes the signal as an Ethernet-based IP television signal. In some embodiments, the IP television signal then flows through a coax conversion router, which converts the Ethernet based IP signal to a coax signal that can travel across a coax network. Once the coax signal reaches the patient's hospital room, it is pushed through an IP modem, which converts the coax signal back to an Ethernet IP signal that is forwarded to a set-top-box (STB) and displayed on the television in the room.

Application content, including both entertainment and various patient-centric applications stored on the application and media server, is requested by the patient via a browser application module that is displayed on the television. The requests travel the same path as television signal, i.e., from the STB through the coax conversion router and IP modem. However, patient requests are directed to the application and media server to be processed. Everything other than the live television signals follows this same routing, including educational videos, movies, and games that are provided via applications stored on the application and media server. The response to a patient request is a generated Web page that is returned to the STB for display within the browser application module on the patient's television. Information stored on the application and media server is also typically provided to the STB and television via the coax conversion router and IP modem.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter; and

FIG. 2 is a chart of a method according to some embodiments of the disclosed subject matter.

### DETAILED DESCRIPTION

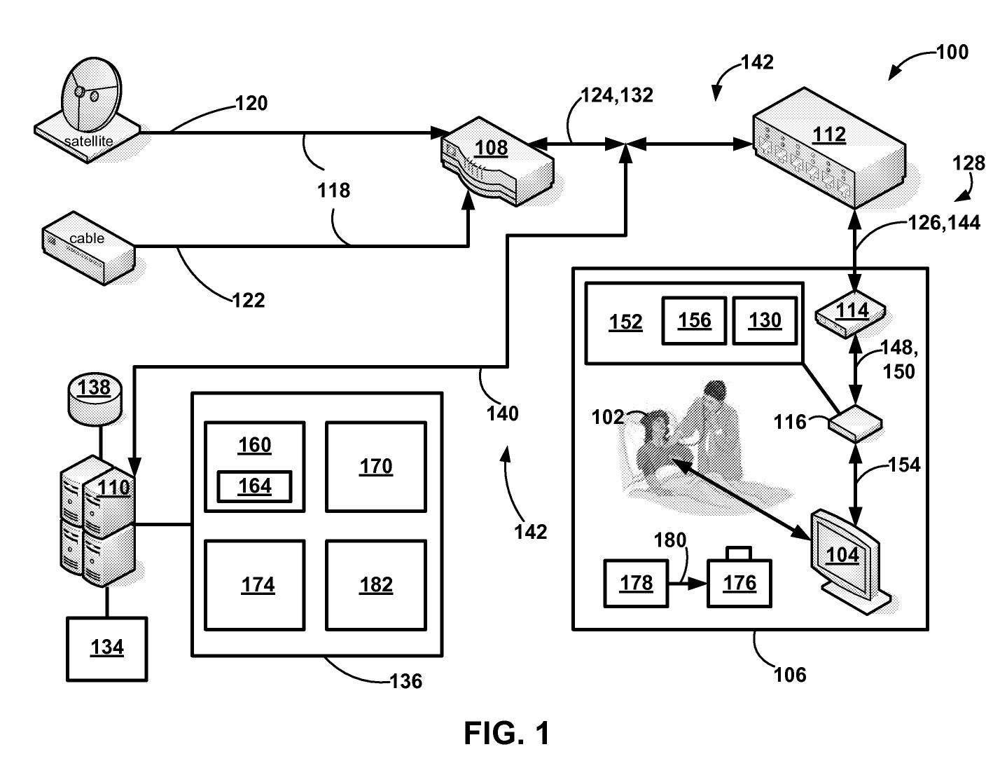

Referring again to FIG. 1, aspects of the disclosed subject matter include an interactive system 100 for communicating with a patient 102 through a television 104 in the patient's hospital room 106. System 100 includes a television signal gateway module 108, an application and media server 110, a coax conversion router 112, an Internet protocol (IP) modem 114, and an interactive STB 116, all of which cooperate with one another.

In system 100, a television signal 118 comes in from either a satellite feed 120 or a cable feed 122 and is pushed through a box known as television signal gateway module 108, which encodes the signal as an Ethernet-based IP television signal 124. In some embodiments, IP television signal 124 then flows through coax conversion router 112, which converts the Ethernet based IP signal to a coax signal 126 that can travel across a coax network 128. Once coax signal 126 reaches hospital room 106, it is pushed through IP modem 114, which converts coax signal 126 back to an Ethernet IP signal that is forwarded to STB 116 and displayed on television 104.

Application content is requested by patient 102 via a browser application module 130 that is displayed on television 104. The requests travel the same path as television signal 118, i.e., from STB 116 through coax conversion router 112 and IP modem 114. However, patient requests are directed to application and media server 110 to be processed. Everything other than the live television signals follows this same routing including educational videos, movies, and games that are provided via applications stored on application and media server 110. The response to a patient request is a generated Web page that is returned to STB 116 for display within browser application module 130 on television 104.

As mentioned above, the preexisting satellite or cable feed, i.e., television signal 118, of the hospital is routed through a piece of equipment known as television signal gateway module 108. Television signal gateway module 108 is responsible for receiving television signal 118, decoding and re-encoding the signal, if necessary, and streaming each television channel as Ethernet-based IP television signal 124. The output of television signal gateway module 108, i.e., Ethernet-based IP television signal 124, is a set of encoded streams 132, e.g., MPEG-2, MPEG-4, or similar, each representing a different television channel. Streams 132 are typically multicast using user datagram protocol (UDP), which means that a separate stream is not required for each individual television watching a particular channel but rather a single channel stream is shared by all televisions watching that channel. Each stream exposed by television signal gateway module 108 is accessed using a specific IP address and port. To access a channel, a media player application need only point to the appropriate address and port to begin to receive the television stream.

Application and media server 110 includes a first information processing sub-system 134, application modules 136, and a database 138. First information processing sub-system 134 is configured to store and process IP television signal 124, other signals, and data according to particular instructions included in application modules 136. Information processing sub-system 134 is configured to generate, send, and receive an Ethernet-based IP application and media signal 140.

Coax conversion router 112 converts Ethernet-based IP television signal 124 and the Ethernet-based IP application and media signal 140 to coax signal 126, which is configured to travel across coax network 128. For information traveling from patient's hospital room 106, e.g., application content requested by patient 102 via browser application module 130, coax conversion router 112 converts coax signal 126 to Ethernet-based IP television signal 124 and Ethernet-based IP application and media signal 140, which are configured to travel across an Ethernet network 142.

IP modem 114 is in communication with coax conversion router 112 via coaxial cable 144. For signals traveling to television 104, IP modem 114 converts coax signal 126 to an Ethernet-based IP signal 148 including IP television signal 124 and IP application and media signal 140. For signals traveling from television 104, IP modem 114 converts Ethernet-based IP signal 148 to coax signal 126 for communication across coax network 128 to coax conversion router 112. In some embodiments, IP modem 114 is external to STB 116. In some embodiments, IP modem 114 is embedded within STB 116 to further limit the hardware footprint in hospital room 106.

In some embodiments, to support the transporting of IP content over a hospital's existing coax network, coax conversion router 112 is a data over cable service interface specification (DOCSIS) router and IP modem 114 is a DOCSIS modem. DOCSIS is a telecommunications standard that supports the addition of high-speed data transfer to a television stream over an existing coax network. It is typically used by cable operators to provide Internet access alongside television over a single line. A scaled down version of DOCSIS from that used by cable providers is used to transmit both television and application content over the existing cable infrastructure of the hospital. Again, this is to prevent the need to replace the coax network at a hospital. If the hospital already has replaced their coax network with an Ethernet network or they are building a new wing and can run Ethernet to the televisions, then conversion of Ethernet-based IP signals is not necessary and coax conversion router 112 and IP modem 114 are not required.

Interactive STB 116 is in communication with IP modem 114 via an Ethernet cable 150. STB 116 includes a second information processing sub-system 152 and browser application module 130. Second information processing sub-system 152 stores and processes instructions included in browser application module 130. Browser application module 130 processes IP television signals 124 and IP application and media signal 140 to produce a television display signal 154. Browser application sub-module receives and processes instructions from patient 102 and communicates the instructions from the patient to application and media server 110. STB 116 communicates television display signal 154 for display on television 104 in patient's hospital room 106. In some embodiments, STB 116 includes a television control module 156 for recording and playback of live television and movies.

In some embodiments, STB 116 is a model FMP2700 as manufactured by Flextronics Company of Singapore running a software suite with the brand name FocusWare, which is produced by ConFocus of Norcross, Ga., on top of a Linux OS. In some embodiments, browser application module 130 includes a television browser developed by the Espial Group of Ottawa, Ontario, which is a Web kit based browser specifically developed by Espial to run in a television environment. The FocusWare software provides an abstraction layer between the hardware and applications running on STB 116. It enables the hardware acceleration required to play video streams given the minimal processing power of a typical STB. It also supplies trick-mode functionality that supports the recording and playback of live television and movies.

In use, application modules 136 of system 100 as well as a live television feed run within browser application module 130, e.g., an Internet browser such as the Espial browser, on STB 116. Videos are typically displayed inside a frame defined within the HTML-based pages of a particular application module. For example, a user selects a particular one of application modules 136 of system 100 by directing the browser of browser application module 130 to a Welcome page displayed on television 104, which lists the applications available to the user. From this page, the user can take a tour of a particular application, they can navigate to their home page, or they can watch television.

When a user watches television, they navigate to a television viewer application module, which is one of application modules 136 stored on application and media server 110 of system 100. The television viewer application module typically displays an Internet page having a number of HTML <div> statements that partition the page into various segments or frames, e.g., an alert area, an application menu, a message area that typically appears at the bottom of the page, and a television display area. The segment that contains the television feed/display has an embedded media player that has the ability to specify a URL that references the television channel to be display. When watching television, the media player points to one of the UDP based streams exposed by television signal gateway module 108 and when the connection is complete the television feed will begin to stream to the player and the television content will be displayed.

Because the media player is embedded into the Internet page displayed by the viewer application module, the other content on the page is accessible alongside the content appearing in the player. This content may not be visible at all times as the media player is typically expanded to fill the screen. However, the page is still fully functional and through the use of a remote or keyboard, the television menu may be displayed at any time. Likewise, there is a background JavaScript timer that polls the server looking for alerts and messages to be displayed to the patient. When one of these messages is received the alert area will slide down from the top of the screen above the television content/display to display the alert/message.

In some embodiments, application modules 136 of system 100 include an alert application module 160. Alert application module 160 includes instructions for displaying an alert area (not shown) via browser application module 130, for pulling data from database 138 in application and media server 110, for formatting and displaying data in the alert area (not shown), and receiving and forwarding patient input back to the application and media server.

Alert application module 160 includes bi-directional communication functionality within system 100 and is used to display timely and important content to patient 102. Alert application module 160 allows patient 102 to respond to questions and menus displayed by the module on a real-time basis. Alert content, e.g., selection menus, ad hoc messages, predefined surveys, etc., is displayed in the alert area (not shown), which slides out from the top of a television screen above the other content actively being viewed by patient 102.

In some embodiments, alert application module 160 includes a messaging sub-module 164 that provides messaging functionality via the alert area (not shown). Messaging sub-module 164 allows both people and systems to communicate through an embedded text parsing and data insertion infrastructure that allows for the on-the-fly formulation of messages that can be directed to one or more recipients as needed. For example, it is used to forward brief alerts to a nurse such as “The patient in MED102 has a high pain level” and it is also used to generate and forward large complex XML documents to external systems as part of an integration scenario.

Messaging sub-module 164 allows for the forwarding of various commands to television in room 106. These commands provide the ability for a staff member sitting at their workstation, or through the use of a mobile device, to remotely instruct television 104 to change the channel being viewed, start an educational video, or request a pain level specification from patient 102. This prevents the staff member from having to enter room 106 to perform this type of menial task, thus making them more efficient and lowering the chance of transferring a communicable disease.

In some embodiments, application modules 136 of system 100 include a remote access application module 170, which includes an Internet-based user interface (not shown) for remotely accessing data from database 138 of application and media server 110. Remote access application module 170 provides access to pre- and post-hospitalization information to patients from outside a hospital. The Internet-based user interface (not shown) is separate and distinct from the Web site that directly accesses application and media server 110 to provide other applications and services of system 100. This separation is required because it is exposed outside the hospital network and therefore must reside outside the firewall that protects system 100. The two sites, however, are linked as database 138 is responsible for supplying all data used by the Internet-based user interface (not shown) of remote access application module 170.

The Internet-based user interface (not shown) of remote access application module 170 is fully aware of the device from which the interface is accessed. This means that, in addition to accessing remote access application module 170 from a laptop or PC, it is also possible to directly access the remote access application module from mobile devices and other non-standard browser based devices, e.g., smartphones, Internet-enabled tablet devices, other Internet-enabled devices, and televisions in a patient's home.

Because the Internet-based user interface (not shown) of remote access application module 170 is publicly accessible, that is it is visible through the Internet and not just the hospitals closed network, a security system is employed that ensures patient information is displayed only to those people to whom access is granted. To ensure a high level of security a number of security measures are included in remote access application module 170: there is no registration process through a Web site, user Ids and passwords must be distributed by the hospital directly to the patient; strong passwords are required including a minimum of 8 password characters and the use of special characters as well as a combination of upper and lower case letters; the use of a random content image for each sign on attempt to prevent brute force password attacks; and no direct access to the database—all data access is limited to business object calls using the pre-defined Web methods that reside behind a firewall. Authentication of the user occurs each time a call is made to one of these methods that access that Web site which directly interacts with application and media server 110 to provide other applications and services of system 100.

In some embodiments, application modules 136 of system 100 include a patient video monitoring application module 174 that provides nurses and other hospital staff with the ability to monitor patient 102 using a camera 176 in patient's hospital room 106. Patient video monitoring module 174 includes a motion sensor 178 positioned in patient's hospital room 106 for sensing when patient 102 moves. Camera 176 is typically a network enable camera that provides two way communications over a standard IP network. In some embodiments, motion sensor 178 is embedded in camera 176. Camera 176 is activated either manually, according to a schedule, automatically in response to a signal 180 from motion sensor 178, or a combination thereof

In some embodiments, application modules 136 of system 100 include a workflow application module 182. Workflow application module 182 includes instructions for automatically generating tasks based on data processed and stored by first information processing sub-system 134. For example, in some embodiments, activation of camera 176 is fully integrated with workflow application module 182 and can cause automated actions to be taken, such as messages being sent or alerts being displayed. In such embodiments, if motion sensor 178 senses that patient 102 attempts to get out of bed, camera 176 is activated, which causes workflow application module 182 to automatically notify the patient's nurse via an alert, text message, etc. As understood by one skilled in the art, it is contemplated that various data processed and stored by first information processing sub-system 134, e.g., data generated by application modules 136, will be analyzed by workflow application module 182, which will in turn automatically generate tasks based on its analyses of the various data.

Workflow application module 182 includes both stateful and stateless workflow definitions that are typically configured to mirror the internal clinical and service processes of a hospital. Stateful workflows are those processes that move through a series of states, or modes of being, over time. For example the process of ordering and receiving a meal may have the following states: Pending Order; Ordered; Delivered; and Cleared.

This series of states along with the actions that can be taken while in each state is described, documented, and processed by a stateful workflow. Stateful workflows are called services within workflow application module 182 as they represent the services that are tracked and managed for the hospital by the application.

Stateless workflows, on the other hand, are those processes that do not change their mode of being and therefore typically do not occur over a measurable period of time (at least in human terms). They instead encompass the individual activities or code blocks that are required to complete a single unit of work. For example, they define the code that is executed when an action is taken within a service. To illustrate this, using the meal ordering example above, when a meal transitions from the Ordered to the Delivered state the following activities might occur: Update the database with the new status; Send a reminder to the wait staff to pick up the empty tray in 1 hour; Update the patient's Electronic Medical Record (EMR) system with the contents of the meal; and Set a timer that will send a message to the nurses in 30 minutes to have them check to make sure the patient has eaten their meal.

Each one of these activities is defined and executed within individual code blocks that are responsible for dealing with that one activity. Stringing these activities together into an execution plan comprises a single stateless workflow.

In addition to handling the transitioning of states within a stateful orchestration, stateless workflows can also be attached to such things as menu selection events and survey results to provide the definition of what should occur upon the event or condition in question. This allows for the dynamic execution of workflows based on a variety of application processes and conditions.

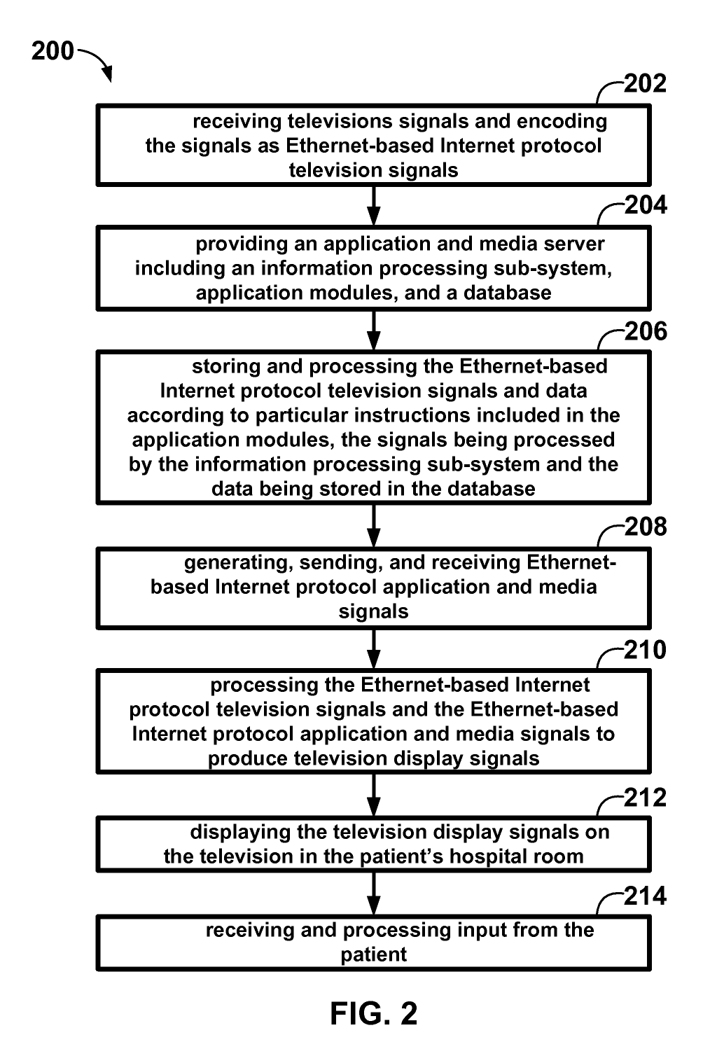

Referring now to FIG. 2, some embodiments include a method 200 for interactively communicating with a patient through a television in the patient's hospital room. At 202, televisions signals are received and encoded as Ethernet-based IP television signals. At 204, an application and media server including an information processing sub-system, application modules, and a database is provided. At 206, in accordance with particular instructions included in the application modules, data is stored in a database and the information processing sub-system processes the Ethernet-based IP television signals. At 208, Ethernet-based IP application and media signals are generated, sent, and received. At 210, the Ethernet-based IP television signals and the Ethernet-based IP application and media signals are processed to produce television display signals. At 212, the television display signals are displayed on the television in the patient's hospital room. At 214, input from the patient is received and processed.

Systems and methods according to the disclosed subject matter offer benefits and advantages over known technology. They offer cost effective applications by using the existing equipment and infrastructure of the hospital as part of the solution. This includes allowing the hospital to continue to use their current cable/satellite provider, supporting any existing televisions they have in place, and operating over the existing cabling infrastructure of the hospital.

The vast majority of hospitals today have an existing coax network in place to support the use of their televisions. The expense of having to replace this coax network with an Ethernet network would be prohibitive both with respect to the monetary cost and the time it would take to put a new network in place. Systems and methods according to the disclosed subject matter provide a solution to convert the IP signal required to deliver both the application content and the television feed over the existing coax infrastructure.

Systems and methods according to the disclosed subject matter keep the size and complexity of the client portion of the application to a minimum in order to maintain a small IT footprint in each room. Having a small footprint has the benefit of not only keeping costs down but also limiting the addition of even more equipment to an already crowded space. Systems according to the disclosed subject matter maintain a small IT footprint by limiting software updates directly on the equipment in each room. Systems according to the disclosed subject matter include a server-side application requiring only a browser to operate. Application updates occur only on the application servers and never need to be pushed out to the equipment in the room thus saving a great deal of IT manpower and time.

Systems and methods according to the disclosed subject matter allow hospital personnel to remain in contact with the patient so that alerts and other communications can be exchanged regardless of what the patient is currently doing in the application. This includes having the ability to ask the patient questions and warn them of upcoming events even when they are watching live television or viewing an educational video. To support this, the television application has the ability to display video feeds, including live television, side-by-side with the other content that comprises the remaining application functionality.

Systems and methods according to the disclosed subject matter extend the engagement of patients beyond the walls of the hospital. They provide the ability for patients to access their information leading up to their stay as well as after they leave. Web sites included in systems according to the disclosed subject matter use industry standard methods and strict security mechanisms to ensure patient data is always available and secure. Systems and methods according to the disclosed subject matter allow a patient to remotely access information such as the following: receiving reminders for pre-admission appointments, labs and x-rays; viewing educational videos; review their Care Team and specify a list of Care Partners; upload scanned documents such as their drivers license and insurance card; online chat with Admission Personnel; receive a checklist of items to bring to the hospital with them; receive an electronic copy of their discharge instructions; receive reminders for follow up appointments; and allow Care Partners remote access to the patient's services such as meals.

Systems and methods according to the disclosed subject matter support timely and appropriate bi-directional interaction, which is critical to engaging patients within the hospital environment. It does this without interrupting the other activities in which the patient is partaking

Systems and methods according to the disclosed subject matter allow for the co-existence of live television and application content within a single viewable area. This provides the means to remain in contact with the patient at all times regardless of what function they are performing within the application. A streamlined solution is employed to convert the television feed into IP, to transport that IP feed over a coax infrastructure and to combine it with other application content on the patient's television. This solution allows systems and methods according to the disclosed subject matter to use much of the existing infrastructure within the hospital and to maintain a small IT footprint.

Systems and methods according to the disclosed subject matter include messaging functionality that is flexible in many ways. The text of messages is predefined with data insertion points and functions and formatted at runtime into simple text messages or into complex messages meant to be interpreted by external systems. Different versions of the same message can be directed to recipients based on the contents of the message they wish to receive and their preferred culture. Also, recipients can be either a person or a device depending on how a hospital designates patient/staff assignments.

Systems and methods according to the disclosed subject matter provide the means to monitor patient activity in a cost effective and unobtrusive way. It supports a variety of situations from constant monitoring of ICU patients to the occasional monitoring of patients that are perhaps not supposed to be out of bed. It also provides the means to bring patients, staff and family members together in video chat rooms where this type of interaction would otherwise not be possible.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An interactive system for communicating with a patient through a television in the patient's hospital room, said system comprising:
a television signal gateway module for receiving a television signal and encoding said signal as an Ethernet-based Internet protocol television signal;
an application and media server including a first information processing sub-system and application modules, said first information processing sub-system being configured to store and process said signal and data according to particular instructions included in said application modules, said information processing sub-system being configured to generate, send, and receive an Ethernet-based Internet protocol application and media signal; and
an interactive set-top-box including a second information processing sub-system and a browser application module, said second information processing sub-system being configured to store and process instructions included in said browser application module, said browser application module being configured to process said Ethernet-based Internet protocol television signal and said Ethernet-based Internet protocol application and media signal to produce a television display signal, said browser application module being configured to receive and process instructions from the patient and communicate said instructions from the patient to said application and media server, said set-top-box being configured to communicate said television display signal for display on the television in the patient's hospital room.

2. The system according to claim 1, further comprising:
a coax conversion router for converting said Ethernet-based Internet protocol television signal and said Ethernet-based Internet protocol application and media signal to a coax signal, and for converting said coax signal to said Ethernet-based Internet protocol television signal and said Ethernet-based Internet protocol application and media signal; and
an Internet protocol modem in communication with said coax conversion router and said set-top-box, said Internet protocol modem being configured to convert said coax signal to an Ethernet-based Internet protocol signal for communication to said set-top-box and configured to convert Ethernet-based Internet protocol signal to said coax signal for communication across said coax network to said coax conversion router.

3. The system according to claim 1, wherein said application modules include an alert application module, said alert application module including instructions for displaying an alert area via said browser application module, for pulling data from said application and media server, for formatting and displaying data in said alert area, and receiving and forwarding patient input back to said application and media server.

4. The system according to claim 3, wherein said alert application module includes a messaging sub-module that provides messaging functionality via said alert area.

5. The system according to claim 3, wherein said alerts include surveys and selection menus.

6. The system according to claim 1, wherein said application modules include a remote access application module, said remote access application module including an Internet-based user interface for remotely accessing data from said application and media server.

7. The system according to claim 1, wherein said application modules include a patient video monitoring application module, said patient video monitoring module comprising:
a motion sensor positioned in the patient's room for sensing when the patient moves; and
a network enable camera configured to provide two way communications over a standard Internet protocol network, wherein said camera is activated either manually, according to a schedule, automatically in response to a signal from said motion sensor, or a combination thereof.

8. The system according to claim 1, wherein said set-top-box includes a television control module for recording and playback of live television and movies.

9. The system according to claim 1, wherein said application modules include a workflow application module, said workflow application module including instructions for automatically generating tasks based on data processed and stored by said first information processing sub-system.

10. A method for interactively communicating with a patient through a television in the patient's hospital room, said method comprising:
receiving televisions signals and encoding said signals as Ethernet-based Internet protocol television signals;
providing an application and media server including an information processing sub-system, application modules, and a database;
storing and processing said Ethernet-based Internet protocol television signals and data according to particular instructions included in said application modules, said signals being processed by said information processing sub-system and said data being stored in said database;
generating, sending, and receiving Ethernet-based Internet protocol application and media signals; and
processing said Ethernet-based Internet protocol television signals and said Ethernet-based Internet protocol application and media signals to produce television display signals; and
displaying said television display signals on the television in the patient's hospital room.

11. The method according to claim 10, further comprising receiving and processing input from the patient.

12. The method according to claim 10, further comprising:
converting said Ethernet-based Internet protocol television signals and said Ethernet-based Internet protocol application and media signals to coax signals, which are configured to travel across a coax network;
converting said coax signals to said Ethernet-based Internet protocol television signals and said Ethernet-based Internet protocol application and media signals, which are configured to travel across an Ethernet network;
converting said coax signals to Ethernet-based Internet protocol signals; and
converting Ethernet-based Internet protocol signals to said coax signals for communication across said coax network.

13. The method according to claim 10, wherein said application modules include an alert application module having instructions comprising:
displaying an alert area on the television in the patient's hospital room;
pulling data from said database on said application and media server;
formatting and displaying data in said alert area; and
receiving and forwarding patient input back to said application and media server.

14. The method according to claim 10, wherein said application modules include a remote access application module having instructions for providing an Internet-based user interface for remotely accessing data from said application and media server.

15. The method according to claim 10, wherein said application modules include a patient video monitoring application module, said patient video monitoring module having instructions comprising:
sensing in a patient's room when the patient moves; and
activating either manually, according to a schedule, automatically in response to sensing when the patient moves, or a combination thereof, a network enable camera configured to provide two way communications over a standard Internet protocol network.

16. The method according to claim 10, wherein said application modules include a workflow application module, said workflow application module including instructions for automatically generating tasks based on data processed and stored by said first information processing sub-system.

17. An interactive system for communicating with a patient through a television in the patient's hospital room, said system comprising:
a television signal gateway module for receiving televisions signals and encoding said signals as Ethernet-based Internet protocol television signals;
an application and media server including a first information processing sub-system, application modules, and a database, said first information processing sub-system being configured to store and process said signals and data according to particular instructions included in said application modules, said information processing sub-system being configured to generate, send, and receive Ethernet-based Internet protocol application and media signals;
a coax conversion router for converting said Ethernet-based Internet protocol television signals and said Ethernet-based Internet protocol application and media signals to coax signals, which are configured to travel across a coax network, and for converting said coax signals to said Ethernet-based Internet protocol television signals and said Ethernet-based Internet protocol application and media signals, which are configured to travel across an Ethernet network;
an Internet protocol modem in communication with said coax conversion router via a coaxial cable, said Internet protocol modem being configured to convert said coax signals to Ethernet-based Internet protocol signals including said Ethernet-based Internet protocol television signals and said Ethernet-based Internet protocol application and media signals and configured to convert Ethernet-based Internet protocol signals to said coax signals for communication across said coax network to said coax conversion router; and
an interactive set-top-box in communication with said Internet protocol modem via an Ethernet cable, said interactive set-top-box including a second information processing sub-system and a browser application module, said second information processing sub-system being configured to store and process instructions included in said browser application module, said browser application module being configured to process said Ethernet-based Internet protocol television signals and said Ethernet-based Internet protocol application and media signals to produce television display signals, said browser application module being configured to receive and process instructions from the patient and communicate said instructions from the patient to said application and media server, said set-top-box being configured to communicate said television display signals for display on the television in the patient's hospital room.

18. The system according to claim 17, wherein said application modules include an alert application module, said alert application module including instructions for displaying an alert area via said browser application module, for pulling data from said database on said application and media server, for formatting and displaying data in said alert area, and receiving and forwarding patient input back to said application and media server.

19. The system according to claim 17, wherein said application modules include a remote access application module, said remote access application module including an Internet-based user interface for remotely accessing data from said application and media server.

20. The system according to claim 17, wherein said application modules include a patient video monitoring application module, said patient video monitoring module comprising:
a motion sensor positioned in the patient's room for sensing when the patient moves; and
a network enable camera configured to provide two way communications over a standard Internet protocol network, wherein said camera is activated either manually, according to a schedule, automatically in response to a signal from said motion sensor, or a combination thereof.
